(19) United States
(12) Patent Application Publication
(10) Pub. No.: US 2026/0101288 A1
(43) Pub. Date: Apr. 9, 2026

(54) METHOD FOR CONTROLLING TRANSMISSION POWER OF SATELLITE COMMUNICATION, AND ELECTRONIC DEVICE THEREFOR

(71) Applicant: Samsung Electronics Co., Ltd., Suwon-si (KR)

(72) Inventors: Jaeho KIM, Suwon-si (KR); Suho JIN, Suwon-si (KR); Dongju LEE, Suwon-si (KR); Hyuntae JUNG, Suwon-si (KR); Yongwoon KIM, Suwon-si (KR)

(21) Appl. No.: 19/416,947

(22) Filed: Dec. 11, 2025

Related U.S. Application Data
(63) Continuation of application No. PCT/KR2024/003616, filed on Mar. 22, 2024.

(30) Foreign Application Priority Data
Jun. 19, 2023 (KR) 10-2023-0078055
Jul. 18, 2023 (KR) 10-2023-0093293

(51) Int. Cl. H04W 52/28; H04B 17/318; H04W 84/06

(52) U.S. Cl. CPC H04W 52/28; H04B 17/318; H04W 84/06

(57) ABSTRACT

An electronic device may comprise: a plurality of antennas, a communication circuit, a memory and at least one processor comprising processing circuitry. When executed by the processor, instructions stored in the memory may cause the electronic device to: receive a request for a satellite communication service; output, with a designated transmission power, a satellite transmission signal for satellite communication using the communication circuit; identify the impedance of a first antenna that has output the satellite transmission signal from among the plurality of antennas; determine whether the identified impedance of the first antenna corresponds to a designated area; and control the power of the satellite transmission signal on the basis of the determination results.

### CROSS-REFERENCE TO RELATED APPLICATIONS

This application is a continuation of International Application No. PCT/KR2024/003616 designating the United States, filed on Mar. 22, 2024, in the Korean Intellectual Property Receiving Office and claiming priority to Korean Patent Application Nos. 10-2023-0078055, filed on Jun. 19, 2023, and 10-2023-0093293, filed on Jul. 18, 2023, in the Korean Intellectual Property Office, the disclosures of each of which are incorporated by reference herein in their entireties.

### BACKGROUND

### Field

The disclosure relates to a method of controlling transmission power of satellite communication and an electronic device thereof.

### Description of Related Art

With the development of digital technology, various types of electronic devices, such as, mobile communication terminals, personal digital assistants (PDAs), electronic organizers, smart phones, tablet personal computers (PC), and/or wearable devices are widely utilized. In order to support and enhance the functions of such electronic devices, the hardware and/or software of electronic devices are continuously improved.

Recently, communication systems are considering the provision of communication services using not only terrestrial base stations but also non-terrestrial entities. For example, the electronic device supports satellite communication using a satellite. Research and development are in progress so as to support satellite communication through connection to a satellite in a state in which the electronic device is difficult to connect to a base station. In an embodiment, satellite communication is attracting attention in terms of reducing shadow areas in which cellular network connection is not available and a communication service is therefore unavailable.

The above-described information may be provided as a related art for helping understanding of the disclosure. No assertion or determination is made as to whether any of the above description is applicable as the prior art related to the disclosure.

An electronic device may transmit a signal at relatively high power when performing satellite communication, as compared to other communication schemes (e.g., 3G and 4G). In the case of transmitting a signal at high power, the conventional technology may prevent/reduce a burnout caused by an operating voltage using an over voltage protection (OVP) circuit. However, the electronic device may not consider the effect of a reflective wave caused by a voltage standing wave ratio (VSWR), and thus may fail to prevent/reduce damage to a communication circuit due to a reflective wave in satellite communication.

### SUMMARY

Embodiments of the disclosure provide a method and device for preventing/reducing the damage (burnout) of a communication circuit by controlling transmission power of a satellite signal when a satellite communication service is provided.

An electronic device according to an example embodiment of the disclosure may include: a plurality of antennas, a communication circuit, a memory, and at least one processor, comprising processing circuitry, and instructions stored in the memory, wherein at least one processor, individually and/or collectively, may be configured to execute the instructions and to cause the electronic device to: receive a request for a satellite communication service, output a satellite transmission signal for satellite communication at specified transmission power using the communication circuit, identify impedance of a first antenna that outputs the satellite transmission signal among the plurality of antennas, determine whether the identified impedance of the first antenna corresponds to a designated region, and control power of the satellite transmission signal based on the determination result.

A method of operating the electronic device according to an example embodiment of the disclosure may include: receiving a request for a satellite communication service, outputting a satellite transmission signal for satellite communication at specified transmission power using the communication circuit of the electronic device, identifying impedance of a first antenna that outputs the satellite transmission signal among the plurality of antennas, determining whether the identified impedance of the first antenna corresponds to a designated region, and controlling power of the satellite transmission signal based on the determination result.

According to an example embodiment, damage to a communication circuit due to high transmission power used in a satellite communication system or a burnout of a communication circuit caused by a reflective wave of a satellite signal may be prevented and/or reduced.

According to an example embodiment, when a problem occurs in a transmission path of satellite communication, by changing the transmission path of the satellite communication, or controlling a transmission path of another communication (e.g., WIFI, GPS, or RF) that shares the transmission path with the satellite communication, a communication service may be smoothly provided.

According to an example embodiment, when a transmission path for use in satellite communication does not exist, control may be performed by limiting a satellite communication service so that problems do not occur in providing other communication services other than satellite communication.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an example electronic device in a network environment according to various embodiments.

FIG. 2 is a block diagram illustrating an example configuration of an electronic device for supporting legacy network communication and 5G network communication according to various embodiments.

FIG. 3 is a diagram illustrating an example communication circuit configuration of an electronic device according to various embodiments.

FIG. 4 is a flowchart illustrating an example method of operating an electronic device according to various embodiments.

FIG. 5 is a graph illustrating an antenna impedance region of an electronic device according to various embodiments.

FIGS. 6A and 6B are diagrams illustrating an example of changing antenna impedance of an electronic device according to various embodiments.

FIG. 7 is a flowchart illustrating an example transmission power control method based on satellite communication of an electronic device according to various embodiments.

FIG. 8 is a diagram illustrating an example of a signal structure of satellite communication of an electronic device according to various embodiments.

FIG. 9 is a flowchart illustrating an example transmission path control method based on satellite communication of an electronic device according to various embodiments.

### DETAILED DESCRIPTION

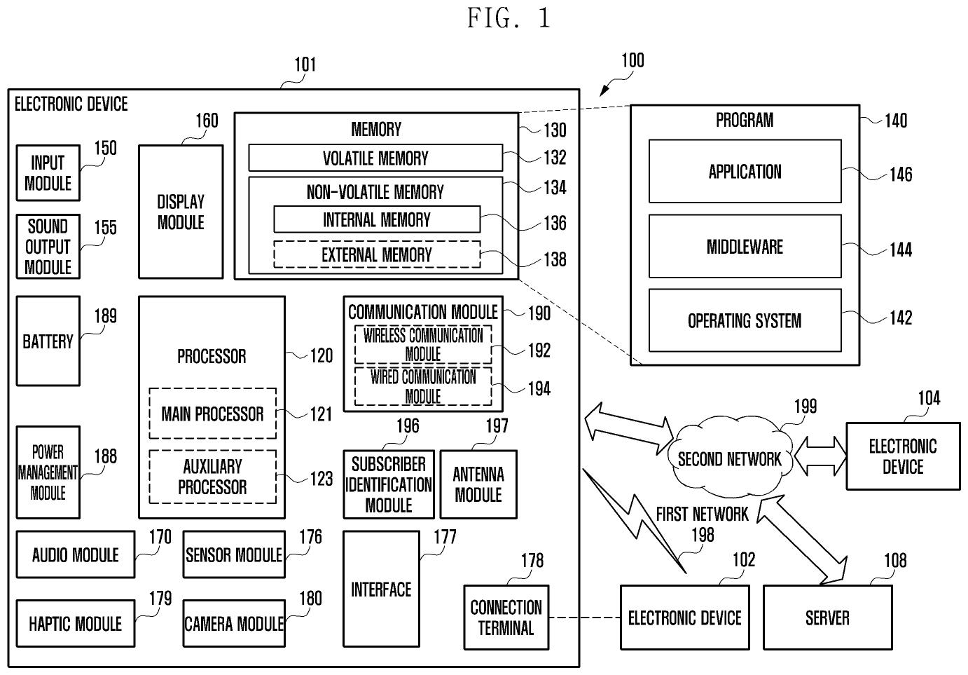

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to certain embodiments, the antenna module 197 may form a mmWave antenna module. According to an embodiment, the mmWave antenna module may include a printed circuit board, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments disclosed herein may be one of various types of electronic devices. The electronic devices may include, for example, a portable communication device (e.g., a smart phone), a computer device, a portable multimedia device, a portable medical device, a camera, a wearable device, a home appliance, or the like. The electronic device according to embodiments of the disclosure is not limited to those described above.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with/to” or “connected with/to” another element (e.g., a second element), the element may be coupled/connected with/to the other element directly (e.g., wiredly), wirelessly, or via a third element.

As used herein, the term “module” may include a unit implemented in hardware, software, or firmware, or any combination thereof, and may be interchangeably used with other terms, for example, “logic,” “logic block,” “component,” or “circuit”. The “module” may be a minimum unit of a single integrated component adapted to perform one or more functions, or a part thereof. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities mat be separately disposed in any other element. According to various embodiments, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

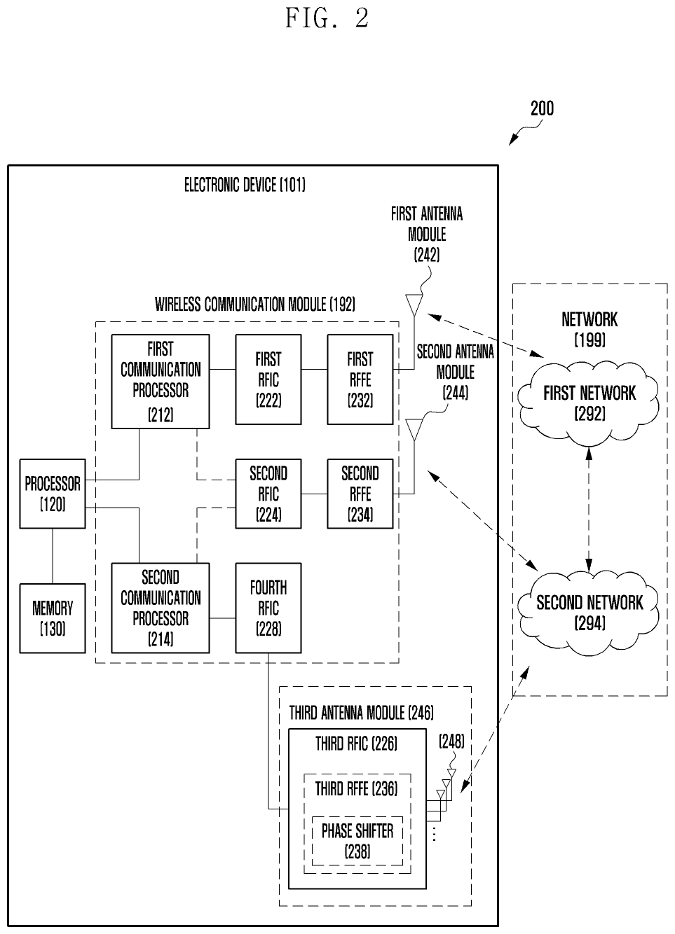

FIG. 2 is a block diagram 200 illustrating an example configuration of an electronic device 101 for supporting legacy network communication and 5G network communication according to various embodiments.

Referring to FIG. 2, the electronic device 101 may include a first communication processor (e.g., including processing circuitry) 212, a second communication processor (e.g., including processing circuitry) 214, a first radio frequency integrated circuit (RFIC) 222, a second RFIC 224, a third RFIC 226, a fourth RFIC 228, a first radio frequency front end (RFFE) 232, a second RFFE 234, a first antenna module (e.g., including at least one antenna) 242, a second antenna module (e.g., including at least one antenna) 244, and an antenna 248. The electronic device 101 may further include a processor (e.g., including processing circuitry) 120 and a memory 130.

The network 199 may include a first network (e.g., a legacy network) 292 and a second network (e.g., a 5G network) 294. According to an embodiment, the electronic device 101 may further include at least one component among the components illustrated in FIG. 1, and the network 199 may further include at least one different network. According to an embodiment, the first communication processor 212, the second communication processor 214, the first RFIC 222, the second RFIC 224, the fourth RFIC 228, the first RFFE 232, and the second RFFE 234 may form at least a part of the wireless communication module 192. According to an embodiment, the fourth RFIC 228 may be omitted or included as a part of the third RFIC 226.

The first communication processor 212 may include various communication processing circuitry and support establishment of a communication channel in a band to be used for wireless communication with the first network 292, and legacy network communication through the established communication channel. According to various embodiments, the first network may be a legacy network including, for example, and without limitation, a 2G, 3G, 4G, or long term evolution (LTE) network. The second communication processor 214 may support establishment of a communication channel corresponding to a designated band (for example, about 6 GHz to about 60 GHz) among bands to be used for wireless communication with the second network 294, and, for example, and without limitation, 5G network communication through the established communication channel. According to various embodiments, the second network 294 may, for example, be a 5G network as referenced by third generation partnership project (3GPP). The description above of the processor 120 applies equally to the first communication processor 212 and the second communication processor 214.

Additionally, according to an embodiment, the first communication processor 212 or the second communication processor 214 may support establishment of a communication channel corresponding to another designated band (for example, about 6 GHz or lower) among the bands to be used for wireless communication with the second network 294, and, for example, 5G network communication through the established communication channel. According to an embodiment, the first communication processor 212 and the second communication processor 214 may be implemented inside a single chip or a single package. According to various embodiments, the first communication processor 212 or the second communication processor 214 may, for example, be provided inside a single chip or a single package together with a processor 120, an auxiliary processor 123, or a communication module 190.

The first RFIC 222 may convert a baseband signal generated by the first communication processor 212 into a radio frequency (RF) signal at about 700 MHz to about 3 GHz, which may be used for the first network 292 (for example, legacy network), during transmission. During reception, an RF signal may be acquired from the first network 292 (for example, legacy network) through an antenna (for example, the first antenna module 242), and may be preprocessed through an RFFE (for example, the first RFFE 232). The first RFIC 222 may convert the preprocessed RF signal into a baseband signal such that the same can be processed by the first communication processor 212.

The second RFIC 224 may convert a baseband signal generated by the first communication processor 212 or the second communication processor 214 into an RF signal in a Sub6 band (for example, about 6 GHz or lower) (hereinafter, referred to as a 5G Sub6 RF signal) that may be used for the second network 294 (for example, 5G network). During reception, a 5G Sub6 RF signal may be acquired from the second network 294 (for example, 5G network) through an antenna (for example, the second antenna module 244), and may be preprocessed through an RFFE (for example, the second RFFE 234). The second RFIC 224 may convert the preprocessed 5G Sub6 RF signal into a baseband signal such that the same can be processed by a communication processor corresponding to the first communication processor 212 or the second communication processor 214.

The third RFIC 226 may convert a baseband signal generated by the second communication processor 214 into an RF signal in a 5G Above6 band (for example, about 6 GHz to about 60 GHz) (hereinafter, referred to as a 5G Above6 signal) that is to be used for the second network 294 (for example, 5G network). During reception, a 5G Above6 RF signal may be acquired from the second network 294 (for example, 5G network) through an antenna (for example, the antenna 248), and may be preprocessed through the third RFFE 236. The third RFIC 226 may convert the preprocessed 5G Above6 signal into a baseband signal such that the same can be processed by the second communication processor 214. According to an embodiment, the third RFFE 236 may be formed as a part of the third RFIC 226.

According to an embodiment, the electronic device 101 may include a fourth RFIC 228 separately from the third RFIC 226 or as at least a part thereof. In this example, the fourth RFIC 228 may convert a baseband signal generated by the second communication processor 214 into an RF signal in an intermediate frequency band (for example, about 9 GHz to about 11 GHz) (hereinafter, referred to as an IF signal) and then deliver the IF signal to the third RFIC 226. The third RFIC 226 may convert the IF signal into a 5G Above6 RF signal. During reception, a 5G Above6 RF signal may be received from the second network 294 (for example, 5G network) through an antenna (for example, antenna 248) and converted into an IF signal by the third RFIC 226. The fourth RFIC 228 may convert the IF signal into a baseband signal such that the same can be processed by the second communication processor 214.

According to an embodiment, the first RIFC 222 and the second RFIC 224 may, for example, be implemented as at least a part of a single chip or a single package. According to an embodiment, the first RFFE 232 and the second RFFE 234 may, for example, be implemented as at least a part of a single chip or a single package. According to an embodiment, at least one antenna module of the first antenna module 242 or the second antenna module 244 may be omitted or coupled to another antenna module so as to process RF signal in multiple corresponding bands.

According to an embodiment, the third RFIC 226 and the antenna 248 may be arranged on the same substrate so as to form a third antenna module 246. For example, the wireless communication module 192 or the processor 120 may be arranged on a first substrate (for example, main PCB). In this example, the third RFIC 226 may be formed on a partial area (for example, lower surface) of a second substrate (for example, sub PCB) that is separate from the first substrate, and the antenna 248 may be arranged in another partial area (for example, upper surface), thereby forming a third antenna module 246. The third RFIC 226 and the antenna 248 may be arranged on the same substrate such that the length of the transmission line between the same can be reduced. This may reduce loss (for example, attenuation) of a signal in a high-frequency band (for example, about 6 GHz to about 60 GHz) used for 5G network communication, for example, due to the transmission line. Accordingly, the electronic device 101 may improve the quality or speed of communication with the second network 294 (for example, 5G network).

According to an embodiment, the antenna 248 may, for example, include an antenna array including multiple antenna elements that may be used for beamforming. In this example, the third RFIC 226 may include multiple phase shifters 238 corresponding to the multiple antenna elements, as a part of the third RFFE 236, for example. During transmission, each of the multiple phase shifters 238 may shift the phase of a 5G Above6 RF signal, which is to be transmitted to the outside (for example, base station of 5G network) of the electronic device 101, through a corresponding antenna element. During reception, each of the multiple phase shifters 238 may shift the phase of a 5G Above6 RF signal received from the outside into the same or substantially same phase through a corresponding antenna element. This enables transmission or reception through beamforming between the electronic device 101 and the outside.

The second network 294 (for example, 5G network) may be operated independently of the first network 292 (for example, legacy network) (for example, standalone (SA)), or operated while being connected thereto (for example, non-standalone (NSA)). For example, the 5G network may include an access network (for example, 5G radio access network (RAN) or next-generation network (NG RAN)) and may not include a core network (for example, next-generation core (NGC)). In this example, the electronic device 101 may access the access network of the 5G network and then access an external network (for example, Internet) under the control of the core network (for example, evolved packed core (EPC)) of the legacy network. Protocol information (for example, LTE protocol network) for communication with the legacy network or protocol information (for example, new radio (NR) protocol information) for communication with the 5G network may be stored in the memory 130, and may be accessed by another component (for example, the processor 120, the first communication processor 212, or the second communication processor 214).

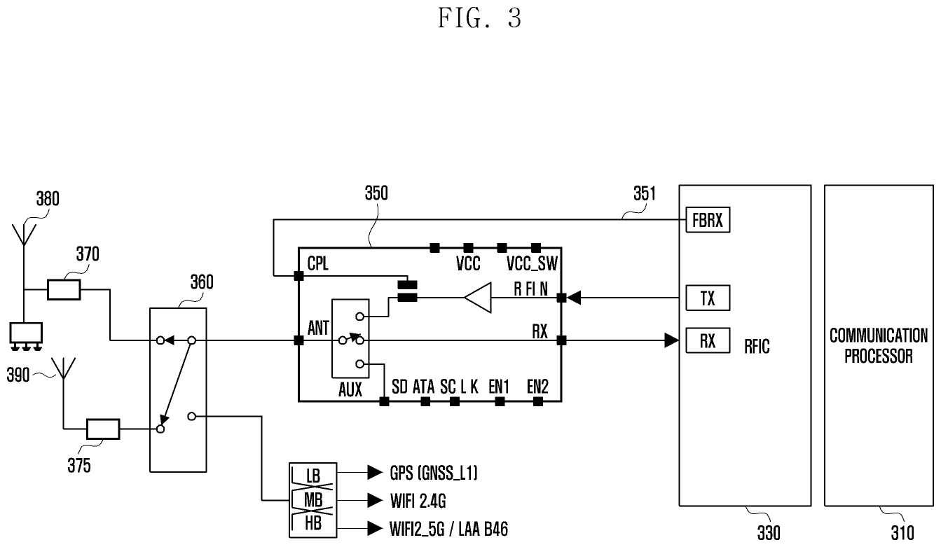

FIG. 3 is a diagram illustrating an example communication circuit configuration of an electronic device according to various embodiments.

Referring to FIG. 3, an electronic device (e.g., electronic device 101 of FIG. 1) according to an embodiment may include a communication processor 310 (e.g., first communication processor 212 and second communication processor 214 of FIG. 2, each including various processing circuitry), an RFIC 330 (e.g., first RFIC 222, second RFIC 224, third RFIC 226, and fourth RFIC 228 of FIG. 2), a communication circuit 350 (e.g., first RFFE 232 and second RFFE 234 of FIG. 2), a first tuner integrated circuit (IC) 370, a second tuner IC 375, a third tuner IC 377, a first antenna 380 (e.g., first antenna module 242, second antenna module 244, and antenna 248 of FIG. 2), and a second antenna 390 (e.g., first antenna module 242, second antenna module 244, and antenna 248 of FIG. 2). The electronic device 101 may further include a processor (e.g., processor 120 of FIG. 1 including various processing circuitry) and a memory (e.g., memory 130 of FIG. 1).

The communication processor 310 may include various processing circuitry and establish a communication channel of a band to be used for wireless communication, and support network communication through the established communication channel. The network communication may include 2nd generation (2G), 3G, 4G, long term evolution (LTE), or 5G as defined in 3GPP.

In the case of transmission, the RFIC 330 may convert a baseband signal generated by the communication processor 310 into a radio frequency (RF) signal used in a network. In the case of reception, when an RF signal received via the first antenna 380 or the second antenna 390 is preprocessed through the communication circuit 350, the RFIC 330 may convert the preprocessed RF signal into a baseband signal so as to be processed by the communication processor 310.

The communication circuit 350 may include a first amplifier for amplifying a transmission signal (e.g., RF transmission signal), and a switch. Although not illustrated in the drawings, the communication circuit 350 may further include a second amplifier (e.g., low-power amplifier) for amplifying a reception signal received through the first antenna 380 or the second antenna 390, or a filter. Although the communication circuit 350 is illustrated as one communication circuit in the drawings, multiple communication circuits may be used.

The switch 360 may control a transmission path of a transmission signal output from the communication circuit 350. The transmission signal may be output through the first antenna 380 or the second antenna 390. The switch 360 may control a transmission path of a transmission signal under the control of the communication processor 310. That is, under the control of the communication processor 310, the switch 360 may output a transmission signal through the first antenna 380 or through the second antenna 390.

The first tuner IC 370 may be a chip (e.g., impedance tuner) for tuning impedance of the first antenna 380 at the start end of the first antenna 380. The second tuner IC 375 may be a chip for tuning impedance of the second antenna 390 at the starting end of the second antenna 390. For example, the first tuner IC 370 or the third tuner IC 377 may be configured based on 256 values. The third tuner IC 377 may be a chip (e.g., aperture tuner) for changing the structure of the first antenna 380 at the end of the first antenna 380. The third tuner IC 377 may be configurable based on 16 values. By changing the configuration values of the first tuner IC 370 and the third tuner IC 377, 4096 configuration values may be configured for the first antenna 380. When the configuration values of the first tuner IC 370 or the third tuner IC 377 are different, a voltage standing wave ratio (VSWR) for each frequency may be different.

Although it is described that the communication processor 310 controls the RFIC 330 or the communication circuit 350 in the drawings, the processor 120 may control the RFIC 330 or the communication circuit 350.

According to an embodiment, in order to prevent and/or reduce damage to the communication circuit 350 due to high transmission power during satellite communication, the communication processor 310 may output a satellite signal (or satellite transmission signal) at low transmission power and may identify the impedance of the current antenna. The communication processor 310 may, upon receiving a request for a satellite communication service, output a satellite signal at specified transmission power. The specified transmission power is for identifying the impedance of the antenna, and may be configured to low transmission power (e.g., 20 dBm). The specified transmission power may be configured in consideration of the characteristics of an antenna or a satellite communication system. The communication processor 310 may identify the impedance of the antenna (e.g., first antenna module 242 to third antenna module 246 in FIG. 2, first antenna 380 and the second antenna 390 in FIG. 3) that has output the satellite signal. For example, in the case in which the antenna that has output the satellite signal is the first antenna 380, the communication processor 310 may identify the impedance of the first antenna 380. Hereinafter, the antenna that has output the satellite signal is to be described as a first antenna 380 by way of example. However, the disclosure is not limited by the above description.

The communication processor 310 may determine whether the identified impedance of the first antenna 380 corresponds to a designated region. The designated region may correspond to a safe region in which the impedance of the first antenna 380 does not cause damage of the communication circuit 350. For example, the designated region may be an impedance region in which a voltage standing wave ratio (VSWR) is less than or equal to a threshold value (e.g., 5). In the case of a non-designated region, it may be an impedance region in which a voltage standing wave ratio (VSWR) exceeds the threshold value. The threshold value may be determined based on the characteristics of the antenna included in the electronic device 101 or the satellite communication system applied to the electronic device 101. That is, the example of the threshold value is to help to understand the disclosure, and the disclosure is not limited by the example. Based on the determination result, the communication processor 310 may control the transmission power of a satellite signal. When the identified impedance of the first antenna 380 corresponds to the designated region, the communication processor 310 may provide a satellite communication service through the first antenna 380.

The communication processor 310 may change the impedance of the first antenna 380 when the identified impedance of the first antenna 380 does not correspond to the designated region. For example, the communication processor 310 may control at least one of the first tuner IC 370, the second tuner IC 375, and the third tuner IC 377, so as to change a tuner configuration value. The electronic device 101 may store a tuner table including a tuner configuration value corresponding to an RF output value in the memory (e.g., memory 130 in FIG. 1). The communication processor 310 may change a tuner configuration value based on the tuner table. The communication processor 310 may change the impedance of the first antenna 380 using a first tuner configuration value. The first tuner configuration value may be a value for moving the impedance of the first antenna 380 to the designated region. After changing the impedance, the communication processor 310 may identify the impedance of the first antenna 380, and determine whether the impedance of the first antenna 380 is moved to the designated region.

When the identified impedance of the first antenna 380 is moved to the designated region after the impedance is changed, the communication processor 310 may transmit a satellite signal through the first antenna 380 at high transmission power. The high transmission power (Max TX power) (e.g., second specified power) may be power higher than the specified power (e.g., first specified power). The high transmission power may be for efficiently transmitting the satellite signal, without causing damage to the communication circuit 350. The communication processor 310 may, after transmitting the satellite signal at high transmission power, change the impedance of the first antenna 380 using a second tuner configuration value. The communication processor 310 may change the impedance of the first antenna 380 using the second tuner configuration value so as to prevent and/or reduce damage to the communication circuit 350 when satellite communication is smoothly performed such as when the impedance of the first antenna 380 corresponds to the designated region. The second tuner configuration value may be different from the first tuner configuration value, and may be a tuner configuration value optimized for reflective wave protection, without considering transmission performance.

According to an embodiment, when using the second tuner configuration value, the communication processor 310 may identify whether the electronic device 101 is gripped or not, and use a separate tuner configuration value based on the identification associated with whether it is gripped or not. The antenna of the electronic device 101 may be disposed in a lateral side of the electronic device 101 or in the rear side of the electronic device 101. The antenna of the electronic device 101 may affect the transmission performance when a user holds the electronic device 101 with his or her hand. For example, when a user holds a location where the first antenna 380 is disposed while the first antenna 380 is used, the transmission performance of the first antenna 380 may be degraded. In this case, the communication processor 310 may change the impedance of the first antenna 380 using a value other than the second tuner configuration value, considering the transmission performance of the first antenna 380.

According to an embodiment, when the satellite communication system used in the electronic device 101 has a time division multiple access (TDMA) structure, the communication processor 310 may configure the second tuner configuration value for the impedance of the first antenna 380 in an uplink used to transmit a satellite signal. The communication processor 310 may use a first default tuner value in a first uplink (UL1), and use the second tuner configuration value in other uplinks (e.g., UL2 to UL14). The communication processor 310 may use the second tuner configuration value between two uplinks (e.g., guard time). For example, when the time (or length) of the entire time slot is 90 ms, the time width of an uplink (or downlink) may be 8.26 ms, and the guard time may be 3.44 ms.

When the impedance of the first antenna 380 is not moved to the designated region even after the impedance is changed, the communication processor 310 may perform a process for controlling a transmission path of the satellite communication. The transmission path control process may measure the signal strength of a reflective wave, and when the measured signal strength of the reflective wave is greater than or equal to a reference value, determine that the transmission path is abnormal, and identify whether another transmission path is normal, and perform control so that the satellite communication is performed via the other transmission path or deactivate the satellite communication.

The communication processor 310 may measure the strength (or power) of a satellite signal (e.g., an incident wave during a forward operation) output to the first antenna 380 from an amplifier (ANT) of the communication circuit 350 and a signal (e.g., a reflective wave during a backward operation) that returns from the first antenna 380. An incident wave may be output to a TX of the RFIC 330→the amplifier (ANT)→the switch 360→the first tuner 370 (and second tuner 377)→the first antenna 380. The reflective wave may be input to the first antenna 380→the first tuner 370→the switch 360→the amplifier (ANT)→the coupler (CPL)→the feedback receiver (FBRX) of the RFIC 330. The communication processor 310 may measure a value (e.g., signal strength) of the FBRX in a path 351 in which a signal is input from the coupler (CPL) of the communication circuit 350 to the RFIC 330, so as to measure the strength (or signal strength) of the incident wave and the reflective wave. The FBRX value may include an in-phase (I) value (or data) or a quadrature-phase (Q) value. The communication processor 310 may configure an antenna tuner through the measurement of the strength of the incident wave and the reflective wave.

The communication processor 310 may determine that the transmission path through the first antenna 380 is defective when the reflective wave has strength greater than or equal to the reference value. When the transmission path is defective, the communication processor 310 may deactivate the first antenna 380, and identify whether another transmission path is normal. When the first antenna 380 is deactivated, each active element of the communication (e.g., GPS/WIFI/RF) for transmitting or receiving a signal through the first antenna 380 may be disabled. Deactivating the first antenna 380 may be to prevent and/or reduce additional damage to the communication circuit 350.

The communication processor 310 may identify whether another transmission path is normal based on a FBRX value and a tuner value of the other transmission path. Here, another transmission path may include a transmission path through the second antenna 390 excluding the first antenna 380. Alternatively, when the electronic device 101 further includes a third antenna (e.g., second antenna module 246 in FIG. 2) or a fourth antenna (e.g., fourth antenna module 248 in FIG. 2), another transmission path may include a transmission path through the third antenna or the fourth antenna. The communication processor 310 may select a transmission path having the highest antenna gain among the second antenna 390 to the fourth antenna, and may incrementally increase the transmission power through the selected antenna, and identify whether the other transmission path is normal.

According to an embodiment, the communication processor 310 may deactivate the satellite communication service when a transmission path for satellite communication does not exist. The communication processor 310 may provide a user interface that guides deactivation of the satellite communication service. When the satellite communication service is deactivated, the communication processor 310 may activate the deactivated first antenna 380 so as to enable another communication (e.g., GPS/WIFI/RF) other than the satellite communication to be performed through the first antenna 380. The user interface may include at least one of text, an image, and a video. The communication processor 310 may output sound through a speaker (e.g., sound output module 155 of FIG. 1) or display a user interface on a display (e.g., display module 160 of FIG. 1) in connection with deactivation of the satellite communication service.

An electronic device according to an example embodiment of the disclosure may include the plurality of antennas 380 and 390, the communication circuit 350, the memory 130, and the processor 120, and instructions stored in the memory may be configured to cause (as used herein, the term “instruction(s) configured to cause” may include the case where instructions are executed by at least one processor, individually and/or collectively to configure at least one processor, individually and/or collectively, to cause the electronic device to perform a recited operation), when executed by the processor, the electronic device to receive a request for a satellite communication service, output a satellite transmission signal for satellite communication at specified transmission power using the communication circuit, identify impedance of a first antenna that outputs the satellite transmission signal among the plurality of antennas, determine whether the identified impedance of the first antenna corresponds to a designated region, and control power of the satellite transmission signal based on the determination result.

The instructions may be configured to cause, when executed by the processor, the electronic device to provide a satellite communication service via the first antenna when the identified impedance of the first antenna corresponds to the designated region, and change the impedance of the first antenna when the identified impedance of the first antenna does not correspond to the designated region.

A tuner table including a tuner configuration value corresponding to a radio frequency (RF) output value is stored in the memory, and the instructions may be configured to cause, when executed by the processor, the electronic device to change a tuner configuration value of the first antenna based on the tuner table stored in the memory.

The instructions may be configured to cause, when executed by the processor, the electronic device to change the tuner configuration value of the first antenna to a first tuner configuration value, identify the impedance of the first antenna after changing the impedance of the first antenna, and when the impedance of the first antenna is moved to the designated region, transmit the satellite transmission signal via the first antenna at second specified power higher than the specified transmission power.

The instructions may be configured to cause, when executed by the processor, the electronic device to change the tuner configuration value of the first antenna to a second tuner configuration value, after transmitting the satellite transmission signal via the first antenna at the second specified power.

The instructions may be configured to cause, when executed by the processor, the electronic device to identify the impedance of the first antenna after changing the impedance of the first antenna; and control a transmission path of satellite communication when the impedance of the first antenna is not moved to the designated region.

The instructions may be configured to cause, when executed by the processor, the electronic device to measure a signal strength of a reflective wave that comes from the first antenna when the impedance of the first antenna is not moved to the designated region, determine whether the signal strength of the reflective wave is greater than or equal to a reference value, and when the signal strength of the reflective wave is greater than or equal to the reference value, deactivate the first antenna.

The instructions may be configured to cause, when executed by the processor, the electronic device to identify whether another transmission path of another antenna excluding the first antenna among the plurality of antennas is normal, after deactivating the first antenna, determine whether a normal transmission path exists among the other transmission paths, and when the normal transmission path exists, select a transmission path based on a gain of each antenna.

The instructions may be configured to cause, when executed by the processor, the electronic device to transmit the satellite transmission signal by incrementally increasing transmission power via a second antenna when the selected transmission path is a transmission path via the second antenna.

The instructions may be configured to cause, when executed by the processor, the electronic device to identify impedance of the second antenna that outputs the satellite transmission signal, determine whether the identified impedance of the second antenna corresponds to the designate region, and control power of the satellite transmission signal based on the determination result.

The electronic device may further include the sound output module 155 and the display 160, and the instructions be configured to cause, when executed by the processor, the electronic device to deactivate satellite communication of the first antenna and activate another communication of the first antenna when the normal transmission path does not exist, and output sound via the sound output module or display a user interface on the display in connection with the deactivation of the satellite communication service.

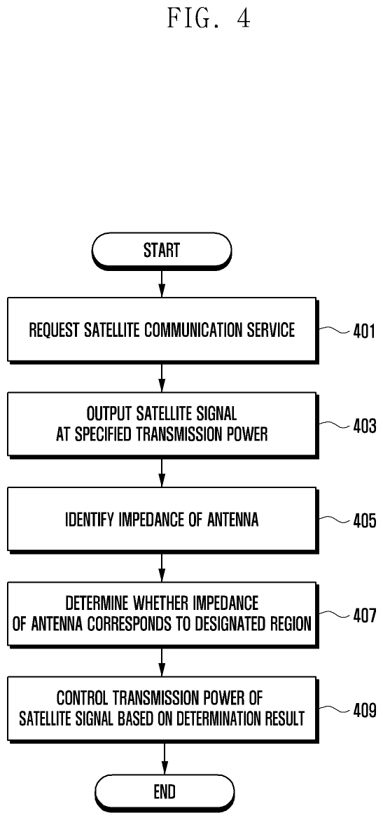

FIG. 4 is a flowchart illustrating an example method of operating an electronic device according to various embodiments.

Referring to FIG. 4, in operation 401, a processor (e.g., processor 120 of FIG. 1) of an electronic device (e.g., electronic device 101 of FIG. 1) according to an embodiment may receive a request for a satellite communication service. For example, when execution of an application for providing a satellite communication service is requested by a user, the processor 120 may determine that the satellite communication service is requested. Although the flowchart of FIG. 4 describes that the processor 120 performs operations, the following operations may also be performed by a communication processor (e.g., first communication processor 212 or second communication processor 214 of FIG. 2, or communication processor 310 of FIG. 3).

In operation 403, the processor 120 may output a satellite signal at specified transmission power. In order to prevent and/or reduce damage to the communication circuit 350 caused by high transmission power during satellite communication, a satellite signal may be output at low transmission power first so as to identify the impedance of the current antenna. The specified transmission power is to identify the impedance of the antenna, and may be configured at low transmission power (e.g., 20 dBm). The specified transmission power may be configured in consideration of the characteristics of an antenna or a satellite communication system. For example, the electronic device 101 may include a plurality of antennas, and the processor 120 may output a satellite signal at specified transmission power through any one of the plurality of antennas. The processor 120 may output a satellite signal at specified transmission power through a first antenna (e.g., first antenna module 242 of FIG. 2, first antenna 380 of FIG. 3). Alternatively, the processor 120 may output the satellite signal at the transmission power through a second antenna (e.g., second antenna module 242 in FIG. 2, second antenna 390 in FIG. 3). Hereinafter, the antenna that has output the satellite signal is to be described as the first antenna 380 by way of example. However, the disclosure is not limited by the above description.

In operation 405, the processor 120 may identify the impedance of the antenna. The processor 120 may identify the impedance of the first antenna 380 that has output the satellite signal among the plurality of antennas. The impedance of the first antenna 380 may be identified based on an FBRX value of an RFIC (e.g., first RFIC 222 of FIG. 2, or RFIC 330 of FIG. 3).

In operation 407, the processor 120 may determine whether the impedance of the antenna corresponds to a designated region. The designated region may correspond to a safe region in which the impedance of the first antenna 380 does not cause damage of the communication circuit 350. For example, the designated region may be an impedance region in which a voltage standing wave ratio (VSWR) is less than or equal to a threshold value (e.g., 5). In the case of a non-designated region, it may be an impedance region in which a voltage standing wave ratio (VSWR) exceeds the threshold value. The threshold value may be determined based on the characteristics of the antenna included in the electronic device 101 or the satellite communication system applied to the electronic device 101.

In operation 409, the processor 120 may control the transmission power of the satellite signal, based on the determination result. When the identified impedance of the first antenna 380 corresponds to the designated region, the processor 120 may provide a satellite communication service through the first antenna 380. The processor 120 may change the impedance of the first antenna 380 when the identified impedance of the first antenna 380 does not correspond to the designated region. For example, the processor 120 may change a tuner configuration value by controlling a tuner IC (e.g., at least one of the first tuner IC 370, the second tuner IC 375, and the third tuner IC 377 in FIG. 3).

According to an embodiment, the electronic device 101 may store a tuner table including a tuner configuration value corresponding to an RF output value in a memory (e.g., memory 130 of FIG. 1). The processor 120 may change the tuner configuration value of the first antenna 380, based on the tuner table The processor 120 may change the impedance of the first antenna 380 using a first tuner configuration value. The first tuner configuration value may be a value for moving the impedance of the first antenna 380 to the designated region. After changing the impedance, the processor 120 may identify the impedance of the first antenna 380, and determine whether the impedance of the first antenna 380 is moved to the designated region.

According to an embodiment, when the impedance of the first antenna 380 is changed, and the identified impedance of the first antenna 380 is moved to the designated region, the processor 120 may transmit a satellite signal through the first antenna 380 at high transmission power (e.g., second specified power higher than the specified transmission power). The high transmission power may be for efficiently transmitting the satellite signal, without causing damage to the communication circuit 350. The processor 120 may, after transmitting the satellite signal at high transmission power, change the impedance of the first antenna 380 using a second tuner configuration value. The second tuner configuration value may be different from the first tuner configuration value, and may be a tuner configuration value optimized for reflective wave protection without considering transmission performance.

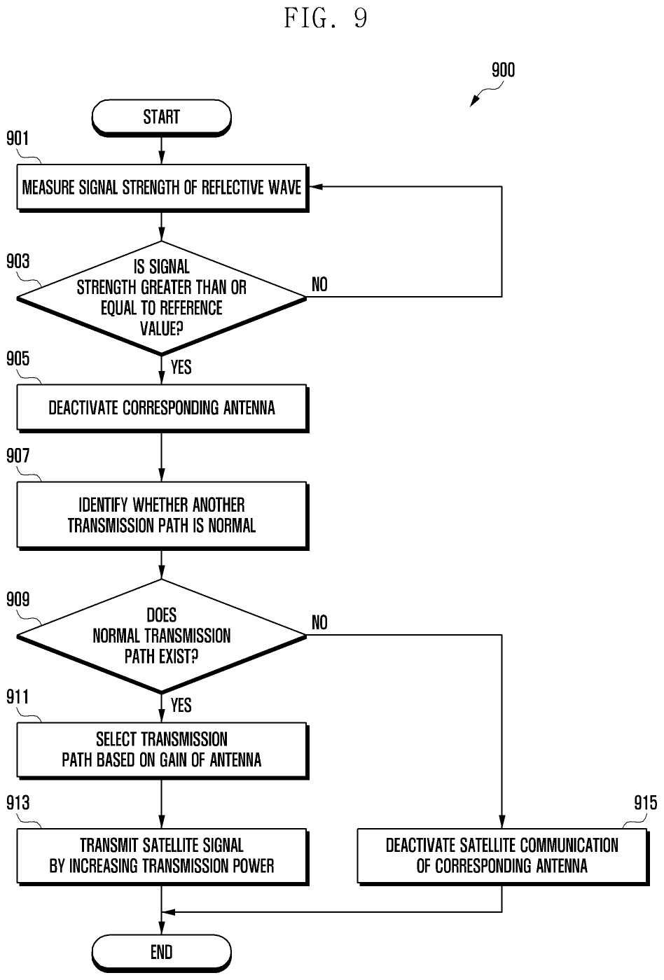

According to an embodiment, even after changing the impedance of the first antenna 380, when the identified impedance of the first antenna 380 does not correspond to the designated region, the processor 120 may perform a process of controlling a transmission path of satellite communication. The process of controlling a transmission path of a satellite communication may correspond to FIG. 9.

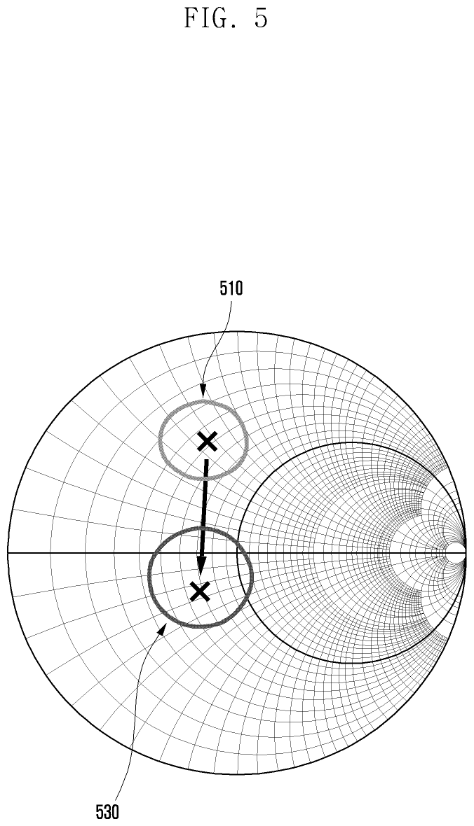

FIG. 5 is a graph illustrating an example antenna impedance region of an electronic device according to various embodiments.

Referring to FIG. 5, the impedance plane may be represented by an in-phase (I) value and a quadrature-phase (Q) value. A first region 510 in the impedance plane may be a dangerous region that may cause damage to a communication circuit (e.g., communication circuit 350 of FIG. 3). A second region 530 is a designated region described in the disclosure, and may be a safe region that does not cause damage to the communication circuit 350. A processor (e.g., processor 120 of FIG. 1) of an electronic device (e.g., electronic device 101 of FIG. 1) according to an embodiment may output a satellite signal at specified transmission power, and then identify the impedance of an antenna (e.g., first antenna module 242 to third antenna module 246 of FIG. 2, first antenna 380 and second antenna 390 of FIG. 3) that has output the satellite signal. When the impedance of the first antenna 380 corresponds to the second region 530, which is the designated region, the processor 120 may provide a satellite communication service through the first antenna 380. When the impedance of the first antenna 380 corresponds to the first region 510, the processor 120 may control a tuner IC (e.g., first tuner IC 370, second tuner IC 375, or third tuner IC 377 of FIG. 3) so as to change the impedance of the first antenna 380.

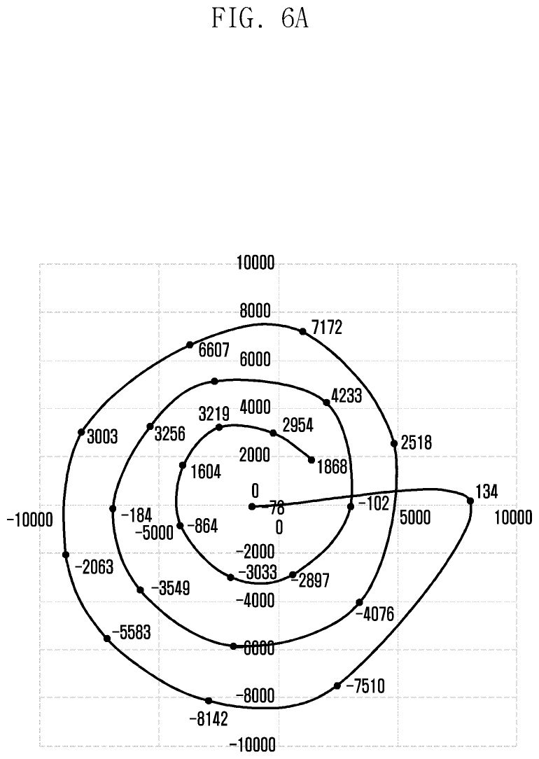

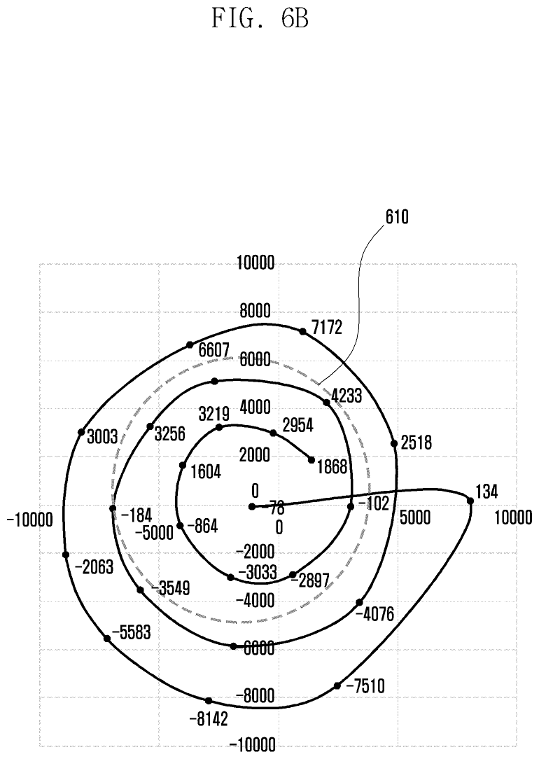

FIGS. 6A and 6B are diagrams illustrating an example of changing antenna impedance of an electronic device according to various embodiments.

Referring to FIG. 6A and FIG. 6B, when the impedance of the first antenna 380 does not correspond to a designated region even after the impedance of the antenna (e.g., first antenna module 242 to third antenna module 246 of FIG. 2, first antenna 380 and second antenna 390 of FIG. 3) that has output a satellite signal is changed, a processor (e.g., processor 120 of FIG. 1) of an electronic device (e.g., electronic device 101 of FIG. 1) according to an embodiment may perform a process of controlling a transmission path of satellite communication. The transmission path control process may measure the signal strength of a reflective wave, and when the measured signal strength of the reflective wave is greater than or equal to a reference value, determine that the transmission path is abnormal, and identify whether another transmission path is normal, and perform control so that the satellite communication is performed via the other transmission path or disable the satellite communication.

The processor 120 may measure the strength (or power) of a satellite signal (e.g., incident wave) output from an amplifier (ANT) of a communication circuit (e.g., communication circuit 350 of FIG. 3) to the first antenna 380 and a signal (e.g., reflective wave) that returns from the first antenna 380. The incident wave may be output to a TX of an RFIC (e.g., RFIC 330 of FIG. 3)→an amplifier (ANT)→a switch (e.g., switch 360 of FIG. 3)→a first tuner (e.g., first tuner 370 of FIG. 3)→the first antenna 380. The reflective wave may be input to the first antenna 380→the first tuner 370→the switch 360→the amplifier (ANT)→a CPL→an FBRX of the RFIC 330. The processor 120 may measure a value of the FBRX in the path 351 in which a signal is input from the coupler (CPL) of the communication circuit 350 to the RFIC 330, so as to measure the strength (or signal strength) of an incident wave and a reflective wave. The FBRX value may include an in-phase (I) value or a quadrature-phase (Q) value. A value obtained by dividing the reflective wave (VREV) by the incident wave (VFWD) may be a reflection coefficient (Tin) which may be expressed as the sum of the I value and the Q value

$$( e . g . , {l}_{in}^{′} = \frac{{V}_{REV}}{{V}_{FWD}} = I + Q ) .$$

In the diagram of FIG. 6A, the X-axis (real number axis) represents I values, and the Y-axis (imaginary number axis) represents Q values, and the numeric value at each point in the diagram may represent a Q coordinate value. The processor 120 may determine whether the transmission path is defective based on an I value and a Q value which correspond to an FBRX value of the communication circuit 350.

In the diagram of FIGS. 6B, I and Q values that are beyond a dotted circle 610 may be considered as defective, and I and Q values included in the dotted circle 610 may be considered as normal.

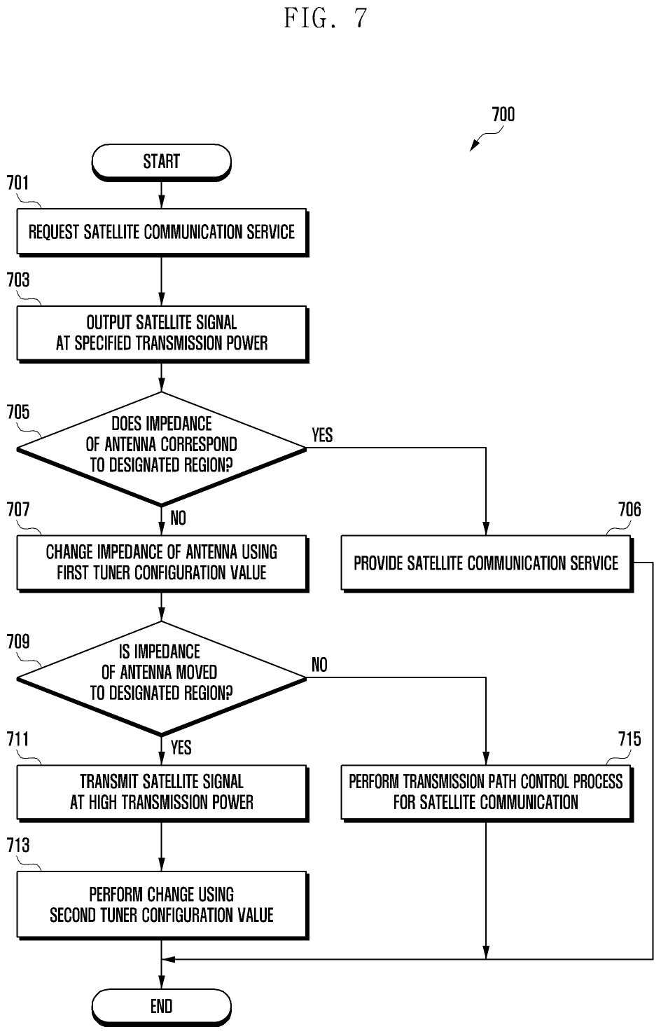

FIG. 7 is a flowchart 700 illustrating an example transmission power control method based on satellite communication of an electronic device according to various embodiments. FIG. 7 may be more specified operations of FIG. 4.

Referring to FIG. 7, in operation 701, a processor (e.g., processor 120 of FIG. 1) of an electronic device (e.g., electronic device 101 of FIG. 1) according to an embodiment may receive a request for a satellite communication service. For example, when execution of an application for providing a satellite communication service is requested by a user, the processor 120 may determine that the satellite communication service is requested. Although the flowchart of FIG. 7 describes that the processor 120 performs operations, the following operations may also be performed by a communication processor (e.g., first communication processor 212 or second communication processor 214 of FIG. 2, or communication processor 310 of FIG. 3).

In operation 703, the processor 120 may output a satellite signal at a first specified transmission power. The first specified transmission power may be for identifying antenna impedance, and may be configured to low transmission power. The specified transmission power may be configured in consideration of the characteristics of an antenna or a satellite communication system. For example, the electronic device 101 may include a plurality of antennas, and the processor 120 may output a satellite signal at specified transmission power through any one of the plurality of antennas. The processor 120 may output a satellite signal at specified transmission power through a first antenna (e.g., first antenna module 242 of FIG. 2, or first antenna 380 of FIG. 3). Operation 703 is similar or identical to operation 403, and thus a detailed description thereof may be omitted

In operation 705, the processor 120 may determine whether the impedance of the antenna corresponds to a designated region. The processor 120 may, after outputting the satellite signal at the specified transmission power, identify the impedance of the first antenna 380 that has output the satellite signal. The impedance of the first antenna 380 may be identified based on an FBRX value of an RFIC (e.g., first RFIC 222 of FIG. 2, RFIC 330 of FIG. 3). The designated region may correspond to a safe region in which the impedance of the first antenna 380 does not cause damage to the communication circuit 350. For example, the designated region may be an impedance region in which a voltage standing wave ratio (VSWR) is less than or equal to a threshold value. The threshold value may be determined based on the characteristics of the antenna included in the electronic device 101 or the satellite communication system applied to the electronic device 101.

The processor 120 may perform operation 706 when the antenna impedance corresponds to the designated region, and may perform operation 707 when the antenna impedance does not correspond to the designated region.

When the impedance of the antenna corresponds to the designated region, the processor 120 may provide a satellite communication service in operation 706. Since the impedance of the first antenna 380 is in a state that does not damage the communication circuit 350, the processor 120 may provide the satellite communication service through the first antenna 380.

When the impedance of the antenna does not correspond to the designated region, the processor 120 may change the impedance of the first antenna 380 using a first tuner configuration value in operation 707. For example, the processor 120 may change a tuner configuration value by controlling a tuner IC (e.g., at least one of the first tuner IC 370, the second tuner IC 375, and the third tuner IC 377 in FIG. 3). According to an embodiment, the electronic device 101 may store a tuner table including a tuner configuration value corresponding to an RF output value in a memory (e.g., memory 130 of FIG. 1). Based on the tuner table, the processor 120 may change the tuner configuration value. The first tuner configuration value may be a value for moving the impedance of the first antenna 380 to the designated region.

In operation 709, the processor 120 may determine whether the impedance of the antenna is moved to the designated region. The impedance of the first antenna 380 may be changed as the first tuner configuration value is changed. After changing the impedance of the first antenna 380, the processor 120 may determine whether the impedance of the first antenna 380 is moved to the designated region.

When the impedance of the first antenna 380 is moved to the designated region, the processor 120 may perform operation 711. When the impedance of the first antenna 380 is not moved to the designated region, the processor 120 may perform operation 715.

When the impedance of the first antenna 380 is moved to the designated region, the processor 120 may transmit (or output) a satellite signal at a second specified transmission power in operation 711. The second specified transmission power (e.g., Max TX power) may be higher than the first specified power. The second specified transmission power may be such that a satellite signal is efficiently transmitted, without causing damage to the communication circuit 350.

In operation 713, the processor 120 may change the value using a second tuner configuration value. The processor 120 may change the impedance of the first antenna 380 using the second tuner configuration value. The second tuner configuration value may be different from the first tuner configuration value, and may be a tuner configuration value optimized for reflective wave protection without considering transmission performance.

According to an embodiment, when using the second tuner configuration value, the processor 120 may identify whether the electronic device 101 is gripped or not, and use a separate tuner configuration value based on the identification associated with whether it is gripped or not. The antenna of the electronic device 101 may be disposed in a lateral side of the electronic device 101 or in the rear side of the electronic device 101. The antenna of the electronic device 101 may affect the transmission performance when a user holds the electronic device 101 with his or her hand. For example, when a user holds a location where the first antenna 380 is disposed while the first antenna 380 is used, the transmission performance of the first antenna 380 may be degraded. In this instance, the processor 120 may change the impedance of the first antenna 380 using a value other than the second tuner configuration value, considering the transmission performance of the first antenna 380.

According to an embodiment, when the satellite communication system used in the electronic device 101 is a TDMA structure, the processor 120 may configure the second tuner configuration value for the impedance of the first antenna 380 used in an uplink for transmitting a satellite signal. Alternatively, the processor 120 may use a first default tuner value in a first uplink (UL1), and use the second tuner configuration value in other uplinks (e.g., UL2 to UL14). Alternatively, the processor 120 may use the second tuner configuration value between two uplinks (e.g., guard time). For example, when the time (or length) of the entire time slot is 90 ms, the time width of an uplink (or downlink) may be 8.26 ms, and the guard time may be 3.44 ms.

When the impedance of the first antenna 380 is not moved to the designated region, the processor 120 may perform a process for controlling a transmission path of the satellite communication in operation 715. The transmission path control process may measure the signal strength of a reflective wave, and when the measured signal strength of the reflective wave is greater than or equal to a reference value, determine that the transmission path is abnormal, and identify whether another transmission path is normal, and perform control so that the satellite communication is performed via the other transmission path or disable the satellite communication. The transmission path control process may include operations of FIG. 9.

According to an embodiment, the processor 120 may measure the strength of a satellite signal output to the first antenna 380 from the amplifier (ANT) of the communication circuit 350 and a signal that returns from the first antenna 380. The processor 120 may determine that the transmission path through the first antenna 380 is defective when the reflective wave has strength greater than or equal to the reference value. When the transmission path is defective, the processor 120 may deactivate the first antenna 380, and identify whether another transmission path is normal or not. Here, another transmission path may include a transmission path through the second antenna 390 excluding the first antenna 380. The processor 120 may identify whether another transmission path is normal based on an FBRX value and a tuner value of the other transmission path. The processor 120 may select a transmission path having the highest antenna gain, and may identify whether another transmission path is normal by gradually increasing transmission power via the selected antenna. When a transmission path for satellite communication does not exist, the processor 120 may deactivate the satellite communication service.

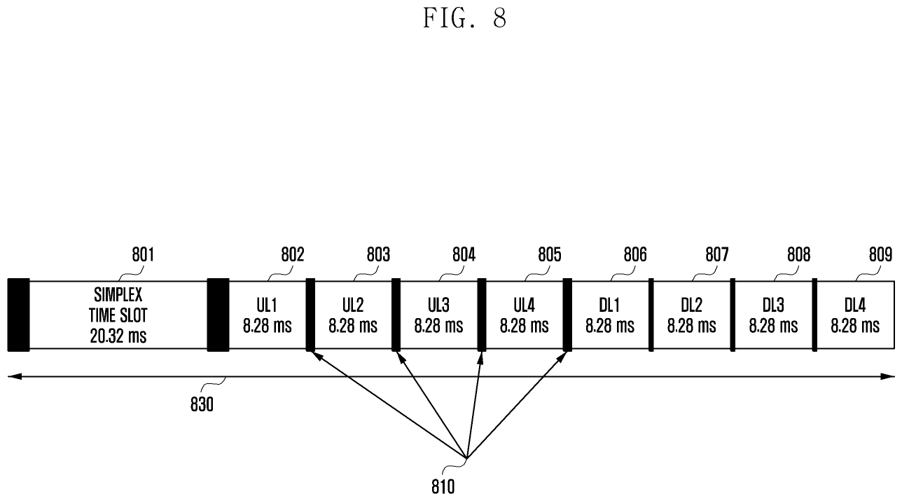

FIG. 8 is a diagram illustrating an example of a signal structure of satellite communication of an electronic device according to various embodiments.

Referring to FIG. 8, the illustrated signal structure of satellite communication may be a TDMA structure of an Iridium satellite communication system. A satellite signal may include a simplex time slot 801, a first uplink 802, a second uplink 803, a third uplink 804, a fourth uplink 805, a first downlink 806, a second downlink 807, a third downlink 808, and a fourth downlink 809. The time of a total time slot 830 of a satellite signal may be 90 ms, and an uplink slot time or a downlink slot time may be 8.28 ms. The time 810 between two uplinks may be 3.44 ms.

A processor (e.g., processor 120 of FIG. 1) of an electronic device (e.g., electronic device 101 of FIG. 1) according to an embodiment may configure a second tuner configuration value for the impedance of an antenna that transmits and receives a satellite signal in the first uplink 802 to fourth uplink 805 used to transmit a satellite signal. Alternatively, the processor 120 may use a first default tuner value in the first uplink 802, and may use the second tuner configuration value in the second uplink 803, the third uplink 804, and the fourth uplink 805. Alternatively, the processor 120 may use the second tuner configuration value between two uplinks 810.

FIG. 9 is a flowchart 900 illustrating an example transmission path control method based on satellite communication of an electronic device according to various embodiments. FIG. 9 illustrates operation 715 of FIG. 7 in greater detail.

Referring to FIG. 9, in operation 901, a processor (e.g., processor 120 of FIG. 1) of an electronic device (e.g., electronic device 101 of FIG. 1) according to an embodiment may measure a signal strength of a reflective wave. The reflective wave may refer to a signal that returns from an antenna (e.g., first antenna 380 in FIG. 3) that has output a satellite signal. For example, the reflective wave may be input to an antenna (e.g., first antenna 380 of FIG. 3) that outputs a satellite signal→a tuner (e.g., first tuner 370 of FIG. 3)→a switch (e.g., switch 360 of FIG. 3)→an amplifier (e.g., amplifier (ANT) of FIG. 3)→a coupler (e.g., CPL of FIG. 3)→an FBRX of an RFIC (e.g., RFIC 330 of FIG. 3). The processor 120 may measure a value of an FBRX in a path in which a signal is input to the RFIC 330 from the coupler (CPL) of the communication circuit (e.g., communication circuit 350 of FIG. 3) so as to measure the strength of the reflective wave (or signal strength).

In operation 903, the processor 120 may determine whether the signal strength is greater than or equal to a reference value. The reference value may be a reference for determining whether a signal path is normal. When the strength of the reflective wave is greater than or equal to the reference value, the processor 120 may perform operation 905, and when the strength of the reflective wave is less than the reference value, the processor 120 may return to operation 901. According to an embodiment, the processor 120 may terminate the process when the strength of the reflective wave is less than the reference value.

When the strength of the reflective wave is greater than or equal to the reference value, the processor 120 may deactivate the corresponding antenna in operation 905. The corresponding antenna may refer to the first antenna 380 that has transmitted the satellite signal. The processor 120 may determine that a transmission path through the first antenna 380 is defective when the reflective wave has strength greater than or equal to the reference value. When the transmission path through the first antenna 380 is defective, the processor 120 may deactivate the first antenna 380. When the first antenna 380 is deactivated, each active element of the communication (e.g., GPS/WIFI/RF) for transmitting or receiving a signal through the first antenna 380 may be disabled. Deactivating the first antenna 380 may be to prevent and/or reduce additional damage to the communication circuit 350.

In operation 907, the processor 120 may identify whether another transmission path is normal. The processor 120 may identify whether another transmission path is normal based on an FBRX value and a tuner value of the other transmission path. Here, another transmission path may include a transmission path through the second antenna 390 excluding the first antenna 380. Alternatively, when the electronic device 101 further includes a third antenna (e.g., second antenna module 246 in FIG. 2) or a fourth antenna (e.g., fourth antenna module 248 in FIG. 2), another transmission path may include a transmission path through the third antenna or the fourth antenna.

In operation 909, the processor 120 may determine whether a normal transmission path exists. For example, the processor 120 may measure an FBRX value of another transmission path, determine whether a signal strength of a reflective wave is greater than or equal to a reference value, and determine that the transmission path is a normal transmission path when the signal strength of the reflective wave is less than the reference value. For example, the processor 120 may identify whether the other transmission path is normal by incrementally increasing transmission power from −9 dB→−6 dB→−3 dB→Max power.

When a normal transmission path exists, the processor 120 may perform operation 911, and when a normal transmission path does not exist, the processor 120 may perform operation 915.

When a normal transmission path exists, the processor 120 may select a transmission path based on a gain of an antenna in operation 911. The gain of each antenna may be stored in a memory (e.g., memory 130 of FIG. 1) of the electronic device 101. For example, based on the gain of the antenna stored in the memory 130, the processor 120 may select a transmission path having the highest antenna gain among the second antenna (e.g., second antenna 390 of FIG. 3) to fourth antenna. For example, the processor 120 may select a transmission path through the second antenna 390.

In operation 913, the processor 120 may transmit a satellite signal by increasing the transmission power. The satellite signal may use power higher than other communication signals, and may cause damage to the communication circuit 350. In order to prevent and/or reduce damage to the communication circuit 350, the processor 120 may transmit the satellite signal by gradually increasing the transmission power. The processor 120 may transmit the satellite signal by gradually increasing the transmission power through the selected second antenna 390. For example, the processor 120 may perform operations 403 to 409 of FIG. 4 through the selected transmission path. That is, the processor 120 may output a satellite signal through the second antenna 390, identify the impedance of the second antenna 390, determine whether the identified impedance of the second antenna 390 corresponds to a designated region, and control the power of the satellite signal based on the determination result.

When there is no normal transmission path, the processor 120 may deactivate the satellite communication of the corresponding antenna in operation 915. The corresponding antenna may refer to the first antenna 380 that has transmitted the satellite signal. The processor 120 may deactivate the satellite communication service when a signal strength of the current transmission path is greater than or equal to a reference value, and there is no transmission path to be used for satellite communication. The processor 120 may activate another communication (e.g., GPS/WIFI/RF) of the first antenna 380. When the processor 120 deactivates the satellite communication service, the processor 120 may activate the first antenna 380 deactivated through operation 905 so that another communication other than the satellite communication may be performed through the first antenna 380.

According to an embodiment, the processor 120 may provide a user interface for guiding the deactivation of the satellite communication service. The user interface may include at least one of text, an image, and a video. The processor 120 may output sound through a speaker (e.g., sound output module 155 of FIG. 1) or display a user interface on a display (e.g., display module 160 of FIG. 1) in connection with the deactivation of the satellite communication service.

A method of operating the electronic device 101 according to an example embodiment of the disclosure may include an operation of receiving a request for a satellite communication service, an operation of outputting a satellite transmission signal for satellite communication at specified transmission power using the communication circuit (350) of the electronic device, an operation of identifying impedance of a first antenna that outputs the satellite transmission signal among the plurality of antennas 380 and 390, an operation of determining whether the identified impedance of the first antenna corresponds to a designated region, and an operation of controlling power of the satellite transmission signal based on the determination result.

The operation of controlling may include an operation of providing the satellite communication service via the first antenna when the identified impedance of the first antenna corresponds to the designated region, and an operation of changing the impedance of the first antenna when the identified impedance of the first antenna does not correspond to the designated region.

A tuner table including a tuner configuration value corresponding to a radio frequency (RF) output value is stored in a memory of the electronic device, and the operation of changing may include an operation of changing a tuner configuration value of the first antenna to a first tuner configuration value based on the tuner table stored in the memory, an operation of identifying impedance of the first antenna after changing the impedance of the first antenna, and an operation of transmitting the satellite transmission signal via the first antenna at second specified power higher than the specified transmission power when the impedance of the first antenna is moved to the designated region.

The method may further include an operation of changing the tuner configuration value of the first antenna to a second tuner configuration value after transmitting the satellite transmission signal via the first antenna at the second specified power.

The method may further include an operation of measuring a signal strength of a reflective wave that comes from the first antenna when the impedance of the first antenna is not moved to the designated region, an operation of determining whether the signal strength of the reflective wave is greater than or equal to a reference value, and an operation of deactivating the first antenna when the signal strength of the reflective wave is greater than or equal to the reference value.

The method may further include an operation of identifying whether another transmission path of another antenna excluding the first antenna among the plurality of antennas is normal, after deactivating the first antenna, an operation of determining whether a normal transmission path exists among the other transmission paths, and selecting a transmission path based on a gain of each antenna when the normal transmission path exists.

The method may further include an operation of transmitting the satellite transmission signal by incrementally increasing transmission power via a second antenna when the selected transmission path is a transmission path via the second antenna.

The method may further include an operation of identifying impedance of the second antenna that outputs the satellite transmission signal, an operation of determining whether the identified impedance of the second antenna corresponds to the designate region, and an operation of controlling power of the satellite transmission signal based on the determination result.

The method may further include an operation of deactivating satellite communication of the first antenna and activating another communication of the first antenna when the normal transmission path does not exist, and an operation of outputting sound via the sound output module or displaying a user interface on the display in connection with the deactivation of the satellite communication service.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a plurality of antennas;
a communication circuit;
a memory; and
at least one processor, comprising processing circuitry,
wherein instructions are stored in the memory, and at least one processor, individually and/or collectively, is configured to execute the instructions and to cause the electronic device to:
receive a request for a satellite communication service;
output a satellite transmission signal for satellite communication at specified transmission power using the communication circuit;
identify impedance of a first antenna that outputs the satellite transmission signal among the plurality of antennas;
determine whether the identified impedance of the first antenna corresponds to a designated region; and
control power of the satellite transmission signal, based on a result of the determination.

2. The electronic device of claim 1, wherein at least one processor, individually and/or collectively, is configured to cause the electronic device to:
based on the identified impedance of the first antenna corresponding to the designated region, provide the satellite communication service via the first antenna; and
based on the identified impedance of the first antenna not corresponding to the designated region, change the impedance of the first antenna.

3. The electronic device of claim 2, wherein a tuner table including a tuner configuration value corresponding to a radio frequency (RF) output value is stored in the memory, and
wherein at least one processor, individually and/or collectively, is configured to cause the electronic device to change a tuner configuration value of the first antenna, based on the tuner table stored in the memory.

4. The electronic device of claim 3, wherein at least one processor, individually and/or collectively, is configured to cause the electronic device to:
change the tuner configuration value of the first antenna to a first tuner configuration value;
after changing the impedance of the first antenna, identify the impedance of the first antenna; and
based on the impedance of the first antenna being moved to the designated region, transmit the satellite transmission signal via the first antenna at second specified power higher than the specified transmission power.

5. The electronic device of claim 4, wherein at least one processor, individually and/or collectively, is configured to cause the electronic device to, after transmitting the satellite transmission signal via the first antenna at the second specified power, change the tuner configuration value of the first antenna to a second tuner configuration value.

6. The electronic device of claim 4, wherein at least one processor, individually and/or collectively, is configured to cause the electronic device to:
after changing the impedance of the first antenna, identify the impedance of the first antenna; and
based on the impedance of the first antenna not being moved to the designated region, control a transmission path of the satellite communication.

7. The electronic device of claim 6, wherein the at least one processor, individually and/or collectively, is configured to cause the electronic device to:
based on the impedance of the first antenna not being moved to the designated region, measure a signal strength of a reflective wave incident from the first antenna;
determine whether the signal strength of the reflective wave is greater than or equal to a reference value; and
based on the signal strength of the reflective wave being greater than or equal to the reference value, deactivate the first antenna.

8. The electronic device of claim 7, wherein at least one processor, individually and/or collectively, is configured to cause the electronic device to:
after deactivating the first antenna, identify whether other transmission paths via antennas other than the first antenna among the plurality of antennas are normal;
determine whether a normal transmission path exists among the other transmission paths; and
based on the normal transmission path existing, select a transmission path, based on a gain of each antenna.

9. The electronic device of claim 8, wherein at least one processor, individually and/or collectively, is configured to cause the electronic device to based on the selected transmission path being a transmission path via the second antenna, transmit the satellite transmission signal while increasing transmission power via the second antenna at a specified rate.

10. The electronic device of claim 9, wherein at least one processor, individually and/or collectively, is configured to cause the electronic device to:
identify impedance of the second antenna that outputs the satellite transmission signal;
determine whether the identified impedance of the second antenna corresponds to the designate region; and
control power of the satellite transmission signal, based on a result of the determination.

11. The electronic device of claim 8, further comprising:
a sound output module comprising circuitry; and
a display,
wherein at least one processor, individually and/or collectively, is configured to cause the electronic device to:
based on the normal transmission path not existing, deactivate the satellite communication of the first antenna and activate another communication of the first antenna; and
based on the deactivation of the satellite communication service, output a sound via the sound output module and/or display a user interface on the display.

12. A method of operating an electronic device, the method comprising:
receiving a request for a satellite communication service;
outputting a satellite transmission signal for satellite communication at specified transmission power using a communication circuit of the electronic device;
identifying impedance of a first antenna that outputs the satellite transmission signal among a plurality of antennas;
determining whether the identified impedance of the first antenna corresponds to a designated region; and
controlling power of the satellite transmission signal, based on a result of the determination.

13. The method of claim 12, wherein the controlling comprises:
based on the identified impedance of the first antenna corresponding to the designated region, providing the satellite communication service via the first antenna; and
based on the identified impedance of the first antenna not corresponding to the designated region, changing the impedance of the first antenna.

14. The method of claim 13, wherein a tuner table including a tuner configuration value corresponding to a radio frequency (RF) output value is stored in a memory of the electronic device, and
wherein the changing comprises:
changing a tuner configuration value of the first antenna to a first tuner configuration value, based on the tuner table stored in the memory;
after changing the impedance of the first antenna, identifying the impedance of the first antenna; and
based on the impedance of the first antenna being moved to the designated region, transmitting the satellite transmission signal via the first antenna at second specified power higher than the specified transmission power.

15. The method of claim 14, further comprising:
after transmitting the satellite transmission signal via the first antenna at the second specified power, changing the tuner configuration value of the first antenna to a second tuner configuration value;

16. The method of claim 14, further comprising:
based on the impedance of the first antenna not being moved to the designated region, measuring a signal strength of a reflective wave incident from the first antenna;
determining whether the signal strength of the reflective wave is greater than or equal to a reference value; and
based on the signal strength of the reflective wave being greater than or equal to the reference value, deactivating the first antenna.

17. The method of claim 16, further comprising:
identifying whether another transmission path of another antenna excluding the first antenna among the plurality of antennas is normal,
after deactivating the first antenna, an operation of determining whether a normal transmission path exists among the other transmission paths, and
selecting a transmission path based on a gain of each antenna when the normal transmission path exists.

18. The method of claim 17, further comprising:
transmitting the satellite transmission signal by incrementally increasing transmission power via a second antenna when the selected transmission path is a transmission path via the second antenna.

19. The method of claim 18, further comprising:
identifying impedance of the second antenna that outputs the satellite transmission signal,
determining whether the identified impedance of the second antenna corresponds to the designate region, and
controlling power of the satellite transmission signal based on the determination result.

20. The method of claim 17, further comprising:
deactivating satellite communication of the first antenna and activating another communication of the first antenna when the normal transmission path does not exist, and
outputting sound via the sound output module or displaying a user interface on the display in connection with the deactivation of the satellite communication service.
